(19) United States
(12) Patent Application Publication
(10) Pub. No.: US 2009/0237368 A1
(43) Pub. Date: Sep. 24, 2009

(54) USER INPUT APPARATUS FOR CONTROLLING IMAGE DISPLAY DEVICE AND METHOD OF CONTROLLING THE IMAGE DISPLAY DEVICE BY USING THE USER INPUT APPARATUS

(75) Inventors: Chang-hwan HWANG, Seoul (KR); Seung-dong YU, Osan-si (KR); Woo-yong CHANG, Yongin-si (KR); Ju-il EOM, Suwon-si (KR); Eun-hee PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/266,046

(22) Filed: Nov. 6, 2008

(30) Foreign Application Priority Data
Mar. 18, 2008 (KR) 10-2008-0024874

(51) Int. Cl. G06F 3/041

(52) U.S. Cl. 345/173

(57) ABSTRACT

Provided is a user input apparatus for controlling an image display device including: a first input unit receiving an instruction to perform a predetermined function of controlling the image display device when a discontinuous signal is received; a second input unit coupled to the first input unit and receiving an instruction to perform a predetermined function of controlling the image display device when a continuous signal is received; and a controller generating a control signal for performing a second function in conjunction with a first function in the image display device when the continuous signal is received from the second input unit within a predetermined period of time after an instruction to perform the first function of controlling the image display device is received from the first input unit.

### CROSS-REFERENCE TO RELATED PATENT APPLICATION

This application claims the benefit of Korean Patent Application No. 10-2008-0024874, filed on Mar. 18, 2008, in the Korean Intellectual Property Office, the disclosure of which is incorporated herein in its entirety by reference.

### BACKGROUND OF THE INVENTION

1. Field of the Invention

Apparatus and methods consistent with the present invention relate to controlling an image display device by using the user input apparatus, and more particularly, to a user input apparatus for controlling an image display device to provide a new manipulation method in combination with a discontinuous method of inputting a signal and a continuous method of inputting a signal.

2. Description of the Related Art

Until recently, a 4-way navigation button and channel/volume buttons of a remote controller have been frequently used together.

FIGS. 1A and 1B are diagrams of 4-way navigation buttons and channel/volume buttons of conventional remote controllers. Referring to FIG. 1A, a 4-way navigation button 110 is combined with channel/volume buttons 111, 112, 113, and 114. Generally, an up button 111 is used to select an upper channel, a down button 112 is used to select a lower channel, a right button 113 is used to increase volume, and a left button 114 is used to reduce the volume. The channel/volume buttons 111, 112, 113, and 114 and the 4-way navigation button 110 having a different function from the channel/volume buttons 111, 112, 113, and 114 may cause users to erroneously operate the remote controller. To address this problem, referring to FIG. 1B, a 4-way navigation button 140, a channel button 120, and a volume button 130 are separated from one another.

However, the 4-way navigation button 140, the channel button 120, and the volume button 130 need to be repeatedly pressed so as to search channels unless the conventional remote controller memorizes all channel numbers, making it impossible to quickly search channels.

### SUMMARY OF THE INVENTION

The present invention provides a user input apparatus for controlling an image display device so as to make a fast channel/volume change in combination with a discontinuous method of inputting a signal and a continuous method of inputting a signal, and a method of controlling the image display device by using the user input apparatus.

According to an aspect of the present invention, there is provided a user input apparatus for controlling an image display device, the user input apparatus comprising: a first input unit receiving an instruction to perform a predetermined function of controlling the image display device when a discontinuous signal is received; a second input unit coupled to the first input unit and receiving an instruction to perform a predetermined function of controlling the image display device when a continuous signal is received; and a controller generating a control signal for performing a second function in conjunction with a first function in the image display device when the continuous signal is received from the second input unit within a predetermined period of time after an instruction for performing the first function of controlling the image display device is received from the first input unit.

The control signal may generate a control signal for performing the first function in the image display device when the continuous signal is received from the second input unit within the predetermined period of time after the instruction for performing the first function of controlling the image display device is received from the first input unit.

The first function may be to make a channel change, and the second function is to make a fast channel change with regard to channels broadcasted to the image display device.

The first function may be to make a volume change in the image display device, and the second function is to make a fast volume change with regard to channels broadcasted to the image display device.

The first input unit may comprise a button based input unit receiving the instruction to perform the predetermined function of controlling the image display device when a pressure is detected, wherein the second input unit comprises a touch based input unit coupled to the button based input unit and receiving the instruction to perform the predetermined function of controlling the image display device when a touch is detected from a touch area of the touch based input unit.

The button based input unit may comprise a 4-way navigation button, and the touch based input unit comprises a touch pad.

The controller may generate a control signal for performing the fast channel change in the image display device when the touch based input unit is scrolled in a circular direction within a predetermined period of time after receiving an instruction to perform the channel change from up or down buttons of the 4-way navigation button.

The predetermined period of time may be indicated by an on screen display (OSD) indicating channel information displayed on the image display device.

The controller may generate a control signal for performing the fast volume change in the image display device when the touch based input unit is scrolled in a circular direction within the predetermined period of time after receiving an instruction to perform the volume change from left or right buttons of the 4-way navigation button.

According to another aspect of the present invention, there is provided a method of controlling an image display device by using a user input apparatus, the method comprising: receiving an instruction to perform a first function of controlling the image display device when a discontinuous signal is received; and generating a control signal for performing a second function in conjunction with the first function in the image display device when a continuous signal is received within a predetermined period of time after receiving the instruction.

According to another aspect of the present invention, there is provided a computer-readable medium to contain computer-readable codes as a program to execute method of controlling an image display device by using a user input apparatus, the method comprising: receiving an instruction to perform a first function of controlling the image display device if a discontinuous signal is received; and generating a control signal for performing a second function in conjunction with the first function in the image display device if a continuous signal is received within a period of time after receiving the instruction

### BRIEF DESCRIPTION OF THE DRAWINGS

The above and other features and aspects of the present invention will become more apparent by describing in detail exemplary embodiments thereof with reference to the attached drawings in which:

FIGS. 1A and 1B are diagrams of 4-way navigation buttons and channel/volume buttons of conventional remote controllers;

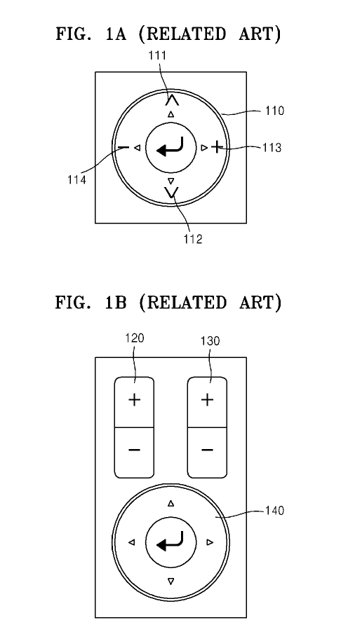

FIG. 2 is a block diagram of a user input apparatus for controlling an image display device according to an embodiment of the present invention;

FIG. 3 is a cross-sectional view of an input apparatus to which a button based input unit and a touch based input unit are attached according to an embodiment of the present invention;

FIGS. 4A and 4B illustrate applications of a touch pad according to an embodiment of the present invention;

FIG. 5 is a diagram of an image display device that displays on screen display (OSD) indicating channel information according to an embodiment of the present invention;

FIGS. 6A and 6B are diagrams of fast channel and volume changes according to an embodiment of the present invention;

FIG. 7 is a flowchart illustrating a method of controlling an image display device by using a user input apparatus according to an embodiment of the present invention; and

FIG. 8 is a flowchart illustrating a fast channel changing method according to an embodiment of the present invention.

### DETAILED DESCRIPTION OF THE INVENTION

The present invention will now be described more fully with reference to the accompanying drawings, in which exemplary embodiments of the invention are shown.

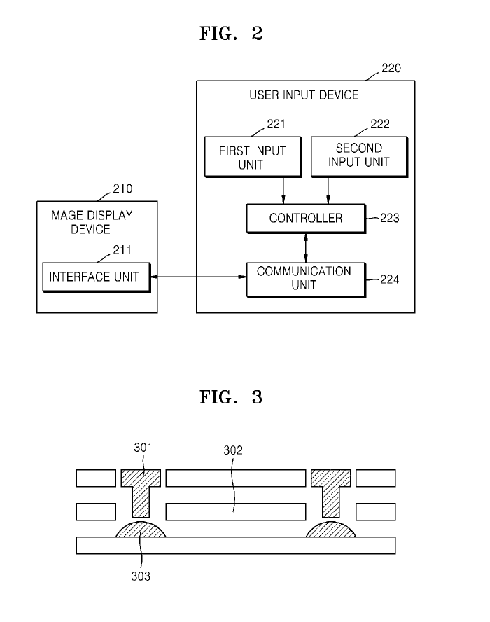

FIG. 2 is a block diagram of a user input apparatus 220 for controlling an image display device 210 according to an embodiment of the present invention. Referring to FIG. 2, the image display device 210 comprises an interface unit 211, and the user input device 220 comprises a first input unit 221, a second input unit 222, a controller 223, and a communication unit 224.

The user input device 220 may be a remote controller for remotely controlling a variety of devices or a key input device of a mobile communication apparatus. However, the present invention is not limited thereto and the user input device 220 may be attached to or separated from an image data reproducing device and may directly control the image data reproducing device.

When the first input unit 221 receives a discontinuous signal, the first input unit 221 receives an instruction to perform a predetermined function of controlling the image display device 210. When the first input unit 221 detects pressure, the first input unit 221 may be a button-based input unit that receives the instruction to perform the predetermined function of controlling the image display device 210. The button-based input unit is a general switch type keypad. Examples of the switch type keypad are a pure mechanical switch type keypad, a form element type keypad, a rubber dome type keypad, a membrane switch type keypad, a capacitive switch type keypad, a composite type keypad, and the like. The switch type keypad of the present embodiment may be the rubber dome type keypad. The rubber dome switch type keypad uses the elasticity of a rubber dome to restitute a button, which is mainly used for a small device. In the present embodiment, the button-based input unit may be a 4-way navigation button. The 4-way navigation button includes up/down/right/left buttons that are used to give an instruction to perform their own intrinsic function. Although not shown, the 4-way navigation button includes a select button in the center thereof. The 4-way navigation button is included in the user input device 220.

When the second input unit 222 is attached to the first input unit 221 and receives a continuous signal, the second input unit 222 receives the instruction to perform the predetermined function of controlling the image display device 210. When the second input unit 222 is attached to the button based input unit and detects a touch from a touch area, the second input unit 222 may be a touch based input unit that receives the instruction to perform the predetermined function of controlling the image display device 210. The touch based input unit refers to a general touch pad. For example, the touch based input unit detects touch based on an electrical change that occurs according to the touch of an object such as a change in capacitance or resistance between electrodes. When the touch based input unit detects a physical touch in the touch area, i.e. a touch, the touch based input unit performs a specific function. The touch based input unit is attached to the button based input unit and is the same size as the button based input unit. The continuous signal refers to a signal received by the user input apparatus 220 in response to a user's scrolling of the touch pad.

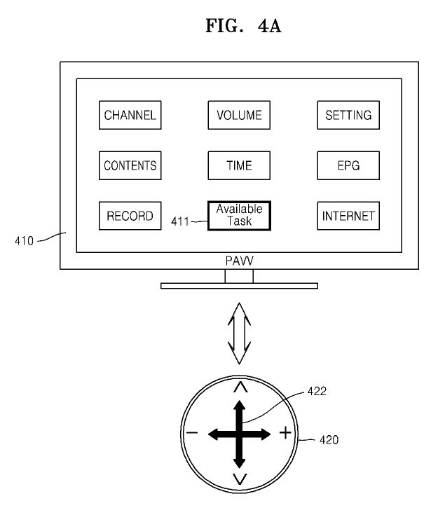

FIG. 3 is a cross-sectional view of an input apparatus to which a button based input unit and a touch based input unit are attached according to an embodiment of the present invention. Referring to FIG. 3, when a button 301 is pressed, a dome 303 is pressed, is connected to a substrate, sends an electrical signal, and performs a specific function corresponding to the button 301. Thereafter, the button 301 is restituted by the elasticity of the dome 303. A touch based input unit 302 is attached to a keypad. The touch based input unit 302 can perform continuous scrolling. In more detail, the touch based input unit 302 performs scrolling without pressing the button 301 so that it is suitable for a fast movement of a predetermined item compared to a button type input unit.

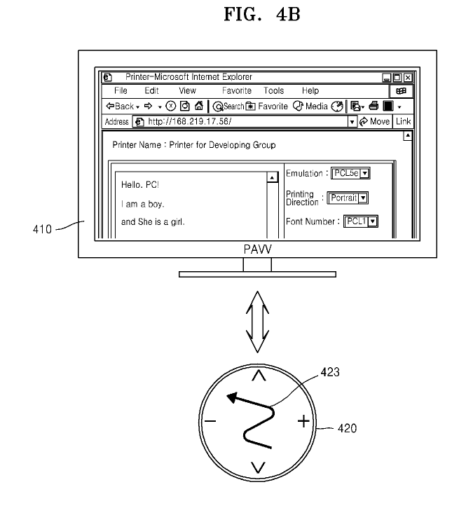

FIGS. 4A and 4B illustrate applications of a touch pad 420. Referring to FIG. 4A, a menu of a digital television (DTV) application is displayed on a screen of an image display device 410 such as a DTV. A user can use up/down/right/left buttons to select an application 411 performing a desired function. A cross arrow 422 indicates a direction in which the user scrolls or drags a touch pad 420 to which a 4-way navigation button is attached. When the user scrolls the touch pad 420 right and left, a selection item moves right and left on the menu. When the user scrolls the touch pad 420 up and down, the selection item moves up and down.

Referring to FIG. 4B, the touch pad 420 can perform a function of a pointer that freely scrolls. When the image display device 410 such as the DTV accesses the Internet, the user scrolls the touch pad 420 in a direction that is not fixed in a Web page so that the touch pad 420 can perform the same function as a mouse.

The controller 223 receives an instruction to perform a first function of controlling the image display device 210, receives the continuous signal from the second input unit 222 within a predetermined period of time, and generates a control signal to perform a second function in conjunction with the first function. The controller 223 may receive an instruction to perform the first function from the button based input unit, detect a touch from the touch based input unit within the predetermined period of time, and generate the control signal to perform the second function in conjunction with the first function. The control signal is transmitted to the interface unit 211 of the image display device 210 through the communication unit 224 so that an application is executed according to the instruction.

The controller 223 receives the continuous signal from the second input unit 222 after the predetermined period of time after receiving the instruction to perform the first function of controlling the image display device 210, and when there is no continuous signal or when an instruction is received from the first input unit 221, the controller 223 generates a control signal for performing the first function in the image display device 210. The controller 223 may receive an instruction to perform the first function of controlling the image display device 210 from the button based input unit, and generate the control signal for performing the first function in the image display device 210 according to the instruction. The control signal is transmitted to the interface unit 211 of the image display device 210 through the communication unit 224, so that an application is executed in the image display device 210 according to the control signal.

When the image display device 210 is a television set or an image device, the first function may be a channel or volume change, and the second function may be a fast channel or volume change, which is coupled to the first function.

The predetermined period of time is indicated by an on screen display (OSD) indicating channel information displayed on the image display device 210. If the first function is the volume change, the predetermined period of time may be a period of time previously designated by the user.

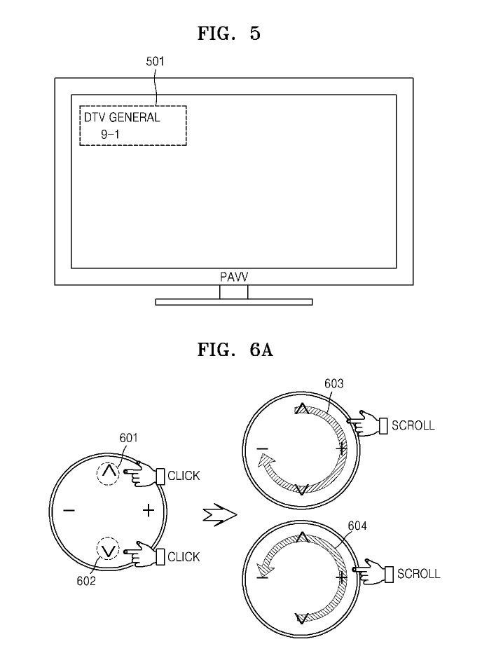

FIG. 5 is a diagram of the image display device 210 that displays OSD 501 indicating channel information according to an embodiment of the present invention. A standby time is needed to view broadcasting after channel manipulation because of quality of content and other additional information in a digital broadcasting environment. A current standby time is about 3.5 seconds. For example, the OSD 501 indicating the channel information including a channel number is only displayed on the image display device 210 before broadcasting starts. In this case, content of a channel can be known after broadcasting starts.

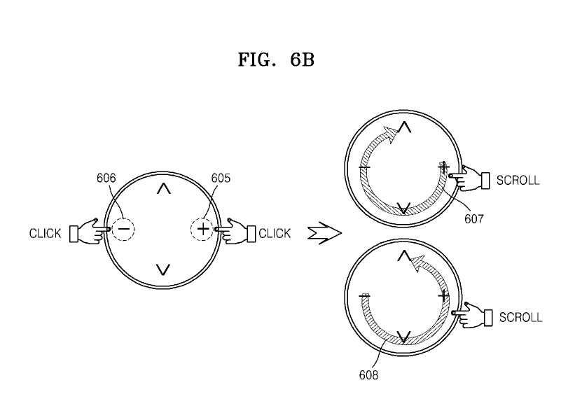

FIGS. 6A and 6B are diagrams of fast channel and volume changes according to an embodiment of the present invention. Referring to FIG. 6A, when a user clicks 4-way navigation buttons 601 and 602, a general channel change is made. When the user clicks an up button 601, an upper channel is selected. When the user clicks a down button 602, a lower channel is selected. After the user clicks the up or down buttons 601 or 602, the fast channel change is made when the user scrolls a touch pad in a rotational direction within a period of time for displaying an OSD indicating channel information on the image display device 210. A clockwise arrow 603 indicates that the user continuously scrolls the touch pad clockwise. In this case, a fast change to an upper channel is made. However, a scrolling direction is not limited to a clockwise direction but may be counter-clockwise. The user starts scrolling the touch pad from the up button 601 indicating a change to the upper channel. A counter-clockwise arrow 604 is that the user continuously scrolls the touch pad counter-clockwise. In this case, a fast change to a lower channel is made. However, a scrolling direction is not limited to counter-clockwise but may be clockwise. The user starts scrolling the touch pad from the down button 602 indicating a change to the lower channel. Alternatively, irrespective of a location in which the user starts scrolling, the fast change to the upper channel may be made by clockwise scrolling, and the fast change to the lower channel may be made by counter-clockwise scrolling.

Referring to FIG. 6B, when the user clicks right/left buttons 605 and 606 of a 4-way navigation button, a general volume change is made. When the user clicks the right button 605, a volume is increased. When the user clicks the left button 606, the volume is reduced. The volume with regard to the left/right buttons 605 and 606 can be determined by a manufacturing company of the image display device 210. After the user clicks the left or right buttons 605 or 606, the fast volume change is made when the user scrolls a touch pad in a rotational direction within a predetermined period of time. A clockwise arrow 607 indicates that the user continuously scrolls the touch pad clockwise. In this case, the volume is increased quickly. However, a scrolling direction is not limited to a clockwise direction but may be counter-clockwise. The user starts scrolling the touch pad from the right button 605 indicating an increase in the volume. A counter-clockwise arrow 608 indicates that the user continuously scrolls the touch pad counter-clockwise. In this case, the volume is reduced quickly. However, a scrolling direction is not limited to a counter-clockwise direction but may be clockwise. The user starts scrolling the touch pad from the left button 606 indicating a reduction in the volume. Alternatively, irrespective of a location where the user starts scrolling, the fast increase of the volume size may be made in clockwise scrolling, and the fast reduction of the volume size may be made in counter-clockwise scrolling. In the present embodiment, the up and down buttons 601 and 602 are used to change channels and the right and left buttons 605 and 606 are used to change the volume. However, the present invention is not limited thereto but the definition of the above buttons can be determined during the manufacturing thereof.

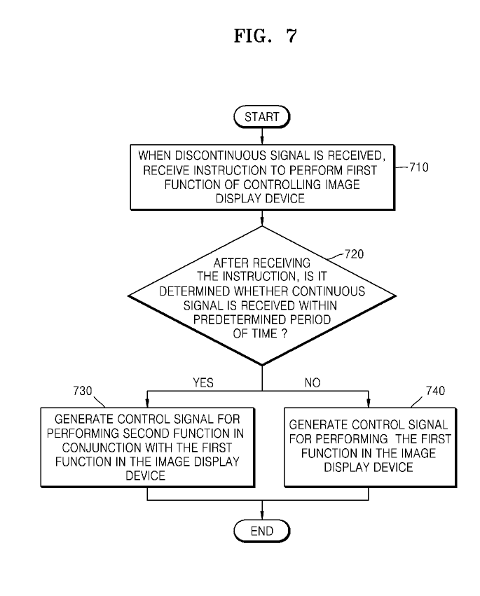

FIG. 7 is a flowchart illustrating a method of controlling an image display device by using a user input apparatus according to an embodiment of the present invention. Referring to FIG. 7, when a discontinuous signal is received, an instruction to perform a first function of controlling the image display device is received (operation 710). In more detail, the instruction to perform the first function of controlling the image display device is received from a button based input unit.

After receiving the instruction to perform the first function, it is determined whether a continuous signal is received within a predetermined period of time (operation 720). In more detail, after receiving the instruction to perform the first function, it is determined whether a touch is detected by a touch based input unit within the predetermined period of time. When the image display device is a television set or an image device, the first function may be a channel or volume change, and a second function may be a fast channel or volume change, which is performed in conjunction with the first function. In the channel change, the predetermined period of time is indicated by an OSD indicating channel information displayed on the image display device.

When the continuous signal is received within the predetermined period of time, a control signal for performing the second function in conjunction with the first function is generated in the image display device (operation 730). When the continuous signal is not received within the predetermined period of time, a control signal for performing the first function in the image display device is generated (operation 740).

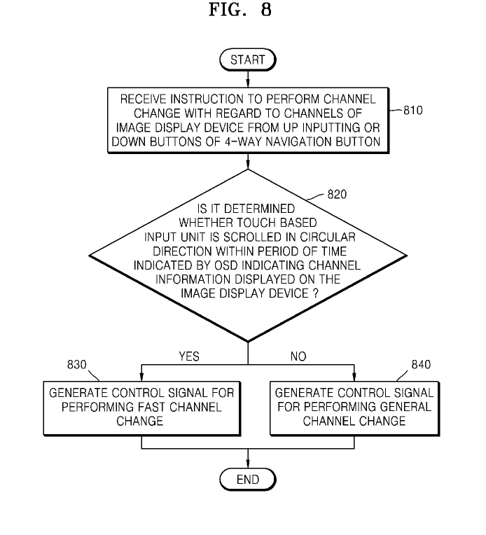

FIG. 8 is a flowchart illustrating a fast channel changing method according to an embodiment of the present invention. Referring to FIG. 8, when a user clicks up or down buttons of a 4-way navigation button, an instruction to perform a channel change with regard to channels of an image display device is received (operation 810). In general, the up button is used to select an upper channel, and the down button is used to select a lower channel.

It is determined whether a second input unit, i.e. a touch based input unit is scrolled in a circular direction within a period of time indicated by an OSD indicating channel information displayed on the image display device (operation 820). In spite of an operation of a channel change, a standby time indicating a channel number that is indicated by the OSD is displayed on the image display device before a program of a changed channel starts. A current standby time is about 3.5 seconds. In a volume change, the standby time may not be displayed on the image display device or may be very short. Therefore, the standby time may be a predetermined period of time determined by a manufacturer of a user input apparatus or the user.

When the touch based input unit is scrolled in the circular direction within the time indicated by the OSD displayed on the image display device, a control signal for performing a fast channel change is generated (operation 830). In the fast channel change to an upper channel, the user continuously scrolls the touch based input unit clockwise. However, the scrolling direction is not limited to a clockwise direction but may be counter-clockwise. The user starts scrolling the touch based input unit from the up button of the 4-way navigation button indicating the change to the upper channel. In the fast channel change to a lower channel, the user continuously scrolls the touch based input unit counter-clockwise. However, the scrolling direction is not limited to a counter-clockwise direction but may be clockwise. The user starts scrolling the touch based input unit from the down button of the 4-way navigation button indicating the change to the lower channel. Alternatively, irrespective of a location where the user starts scrolling, the fast change to the upper channel may be made by clockwise scrolling, and the fast change to the lower channel may be made by counter-clockwise scrolling. In the volume change, the up and down buttons for the channel change correspond to right and left buttons. A fast volume changing method is similar to the fast channel changing method. When the right button is clicked and is scrolled in a rotational direction, a fast increase in volume is performed. When the left button is clicked and is scrolled in the rotational direction, a fast reduction in volume is performed. Unlike the channel change, time indicated by the OSD displayed on the image display device may be a predetermined period of time determined by the manufacturer of the user input apparatus or the user.

When the touch based input unit is scrolled in the rotational direction after the time indicated by the OSD displayed on the image display device or is not scrolled, a control signal for performing a general channel change is generated (operation 840).

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. In another embodiment, the computer readable recording medium can also be distributed network coupled computer systems so that the computer readable code is stored and executed in a distributed fashion. Also, functional programs, code and code segments for accomplishing the present invention can be easily construed by programmers of ordinary skill in the art to which the present invention pertains.

The user input apparatus for controlling the image display device and the method of controlling the image display device by using the user input apparatus according to the present invention can quickly change channel/volume, thereby increasing user convenience. Also, the present invention can perform a new function by using a combination of a button and a touch pad.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A user input apparatus for controlling an image display device, the user input apparatus comprising:
a first input unit which receives an instruction to perform a first function of controlling the image display device if a discontinuous signal is received;
a second input unit coupled to the first input unit which receives the instruction to perform a second function of controlling the image display device if a continuous signal is received; and
a controller which generates a control signal for performing the second function in conjunction with the first function in the image display device if the continuous signal is received from the second input unit within a period of time after the instruction for performing the first function of controlling the image display device is received from the first input unit.

2. The user input apparatus of claim 1, wherein the controller generates a control signal for performing the first function in the image display device if the continuous signal is not received from the second input unit within the period of time after the instruction for performing the first function of controlling the image display device is received from the first input unit.

3. The user input apparatus of claim 1, wherein the first function comprises a channel change function, and the second function comprises a fast channel change function with regard to channels broadcasted to the image display device.

4. The user input apparatus of claim 1, wherein the first function comprises a volume change function in the image display device, and the second function comprises a fast volume change function with regard to channels broadcasted to the image display device.

5. The user input apparatus of claim 1, wherein the first input unit comprises a button based input unit which receives the instruction to perform the first function of controlling the image display device if a pressure is detected,
wherein the second input unit comprises a touch based input unit coupled to the button based input unit which receives the instruction to perform the second function of controlling the image display device if a touch is detected from a touch area of the touch based input unit.

6. The user input apparatus of claim 5, wherein the button based input unit comprises a 4-way navigation button, and the touch based input unit comprises a touch pad.

7. The user input apparatus of claim 6, wherein the controller generates a control signal for performing a fast channel change function in the image display device if the touch based input unit is scrolled in a circular direction within a period of time after receiving an instruction to perform a channel change function from up or down buttons of the 4-way navigation button.

8. The user input apparatus of claim 7, wherein the period of time is indicated by an on screen display (OSD) indicating channel information displayed on the image display device.

9. The user input apparatus of claim 6, wherein the controller generates a control signal for performing a fast volume change function in the image display device if the touch based input unit is scrolled in a circular direction within a period of time after receiving an instruction to perform a volume change function from left or right buttons of the 4-way navigation button.

10. A method of controlling an image display device by using a user input apparatus, the method comprising:
receiving an instruction to perform a first function of controlling the image display device if a discontinuous signal is received; and
generating a control signal for performing a second function in conjunction with the first function in the image display device if a continuous signal is received within a period of time after receiving the instruction.

11. The method of claim 10, further comprising: generating a control signal for performing the first function in the image display device if the continuous signal is not received within the period of time after receiving the instruction.

12. The method of claim 10, wherein the first function comprises a channel change function, and the second function comprises a fast channel change function with regard to channels broadcasted to the image display device.

13. The method of claim 10, wherein the first function comprises a volume change function in the image display device, and the second function comprises a fast volume change function with regard to channels broadcasted to the image display device.

14. The method of claim 10, wherein the user input apparatus comprises a touch pad and a 4-way navigation button coupled to the touch pad.

15. The method of claim 14, wherein the receiving of the instruction to perform the first function comprises: receiving an instruction to perform a channel change function from up or down buttons of the 4-way navigation button,
wherein the generating of the control signal for performing the second function comprises: generating a control signal for performing a fast channel change function in the image display device if the touch pad is scrolled in a circular direction within a period of time after receiving an instruction to perform the channel change.

16. The method of claim 15, wherein the period of time is indicated by an on screen display (OSD) indicating channel information displayed on the image display device.

17. The method of claim 14, wherein the receiving of the instruction to perform the first function further comprises: receiving an instruction to perform a volume change function from left or right buttons of the 4-way navigation button,
wherein the generating of the control signal for performing the second function further comprises: generating a control signal for performing a fast volume change function in the image display device if the touch pad is scrolled in a circular direction within a period of time after receiving an instruction to perform the volume change function.

18. A computer-readable medium to contain computer-readable codes as a program to execute method of controlling an image display device by using a user input apparatus, the method comprising:
receiving an instruction to perform a first function of controlling the image display device if a discontinuous signal is received; and
generating a control signal for performing a second function in conjunction with the first function in the image display device if a continuous signal is received within a period of time after receiving the instruction.
